(19) United States
(12) Patent Application Publication
(10) Pub. No.: US 2006/0008617 A1
(43) Pub. Date: Jan. 12, 2006

(54) Floor mat

(76) Inventor: Mohamed Sourang, St-Hubert (CA)

Correspondence Address: Eric Fincham, 316 Knowlton Road, Lac Brome, QC, J0E 1V0, CA

(21) Appl. No.: 11/174,717

(22) Filed: Jul. 5, 2005

(30) Foreign Application Priority Data
Jul. 6, 2004 (CA) 2,473,058

(51) Int. Cl. B32B 3/10; B32B 3/28

(52) U.S. Cl. 428/138; 428/167

(57) ABSTRACT

A floor mat suitable for use in automobiles, the floor mat having an upper fabric layer permeable to a liquid, a central absorbent layer underlying the fabric layer, an impermeable layer underlying the absorbent layer, and preferably a lower fabric layer underlying the impermeable layer. The mat may be used in conjunction with a tray of a conventional structure, the tray having apertures therein to permit drainage of liquid therethrough.

### FIELD OF THE INVENTION

The present invention relates to floor mats suitable for use in automobiles and other motor vehicles and more particularly, relates to floor mats which may be arranged to completely protect the floor area of the vehicle and which can be custom designed.

### BACKGROUND OF THE INVENTION

Accessory floor mats are well known in the art and are widely used to protect the carpeted floor of vehicles. The mats may be made of various materials and some are formed by injection molding of thermoplastic materials. It is also known in the art to have an upper portion thereof formed of a different material such as a textile material.

Frequently, the floor mats are formed with prongs on the side facing the carpet of the vehicle which dig in or grab the carpet fibers to prevent sliding movement so as to keep the floor mat in position. Alternative methods include the use of various straps, or snaps or a foam and loop type of attachment such as those marketed under the trademark “VELCRO”.

A problem with floor mats, particularly in climates which have a lot of snow, is the disposal of the snow or ice brought into the vehicle. Thus, the snow or ice, once melted, tends to accumulate on the floor of the vehicle. In the case of thermoplastic mats, it has been proposed in the art to make them deeper and to have high interior ribs such that the mat will be able to contain a substantial volume of liquid to prevent damage to the pant legs of the driver or passenger. In the case of floor mats having a textile upper surface, attempts have been made to make the surface as absorbent as possible.

A further problem which is encountered relates to common use of sodium chloride or calcium chloride to melt the snow on the road. This salt is brought into the vehicle and tends to stain the carpets and area around the carpet. After a certain period of time it becomes next to impossible to remove these stains.

### SUMMARY OF THE INVENTION

It is an object of the present invention to provide a floor mat suitable for use in automobile interiors which overcomes the above disadvantages.

It is a further object of the present invention to provide a floor mat system which is designed to retain liquid therein.

According to one embodiment of the present invention, there is provided, a mat suitable for protecting the floor of a vehicle, the mat comprising an upper fabric layer permeable to a liquid, a central absorbent layer underlying the fabric layer and an impermeable layer underlying the absorbent layer.

In a further aspect of the present invention, there is provided a carpet protection system comprising a mat and a tray, the mat comprising an upper fabric layer permeable to a liquid, a central absorbent layer underlying the fabric layer, an impermeable layer underlying the absorbent layer and the tray having a bottom with a plurality of ribs extending outwardly from the bottom, and a plurality of apertures formed in the bottom such that liquid on the tray will drain to the mat.

The upper layer is utilized to protect the surface of the layer below and also to direct any liquid into the layer below. The upper layer may be formed of any suitable fabric, either of a natural or synthetic material. A preferred material is polyester. Needless to say, the upper layer is designed to be permeable to liquids.

The second layer comprises an absorbent material. In this respect, the most important characteristic of this layer is the ability to absorb a liquid and retain the liquid within the layer. Preferably, this layer also provides the characteristics of being relatively firm while still retaining a certain flexibility. Preferably, the material is one which has the ability to be washed. The material may be formed of many different natural or synthetic materials including polyesters, polymeths, acrylics, polypropylene, combinations thereof, etc. Preferably, the material is formed of a recycled material.

The absorbent layer preferably has a capacity of absorbing between 600 and 800% of its own weight of a liquid, this being done at a relatively rapid rate. The total capacity of the mat will naturally depend upon the thickness of the material. To this end, a thickness of between 5 and 20 mm is preferred while a more preferred thickness is between 7 and 12 mm. At a thickness of approximately 10 mm, the layer would be capable of absorbing at least 7500 grams of liquid per square meter.

Laying underneath the absorbable layer is a impermeable film layer. This layer can be relatively thin and formed of any suitable material such as a plastic or rubber material. A preferred material would be a polyurethane thermoplastic which would generally have a thickness of between 1 and 3 mm.

Underneath the impermeable layer, there may be provided a lower fabric layer to protect the surface of the impermeable layer. Again, any suitable material, either synthetic or natural, may be utilized with a preferred material being a polyester material.

The mat is designed to be machine washable and dryable. Naturally, the capability of washing and drying will depend upon the capacity of the appliance used.

In one embodiment of the present invention, there is provided a carpet protection system which utilizes the above defined mat in conjunction with a conventional floor tray mat which is designed to retain water therein. Preferably, the tray is formed so as to have drainage apertures therein to drain to the mat of the present invention.

### BRIEF DESCRIPTION OF THE DRAWINGS

Having thus generally described the invention, reference will be made to the accompanying drawings illustrating embodiments thereof, in which:

FIG. 1 is a perspective view of one embodiment of a tray and mat according to the present invention;

FIG. 2 is a cross sectional view of a portion of the tray and mat;

FIG. 3 is a top plan view of the mat prior to placement in the vehicle;

FIG. 4 is a top plan view of the one embodiment of a tray according to the present invention;

FIG. 5 is a top plan view of a different arrangement of the tray and mat;

FIG. 6 is a top plan view illustrating a different configuration for a mat; and

FIG. 7 is a top plan view of a still different configuration of a mat according to the present invention.

### DESCRIPTION OF THE PREFERRED EMBODIMENTS

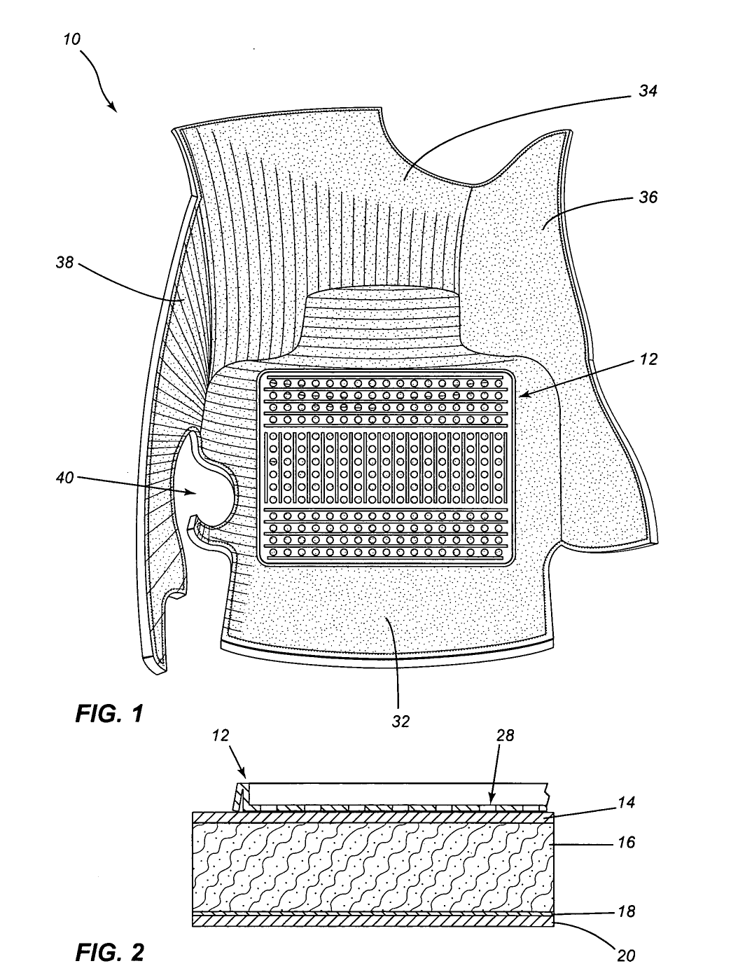

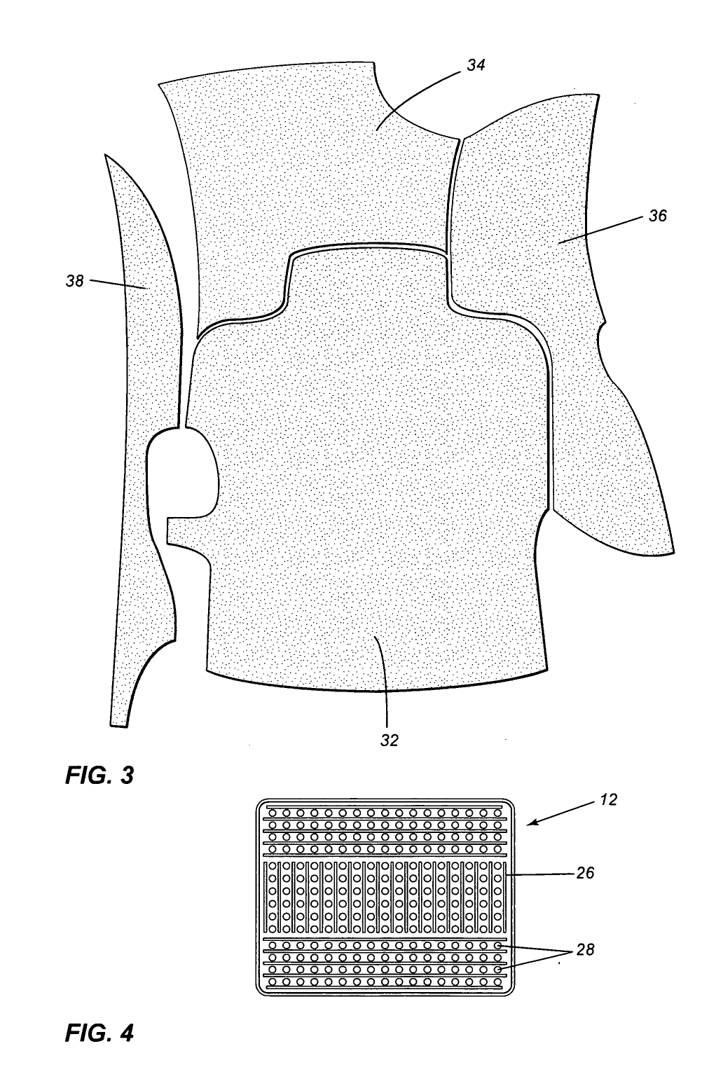

Referring to the drawings in greater detail and by reference characters thereto, there is illustrated in FIG. 1 a carpet protection system suitable for use in one type of automobile configuration. In this system, there is provided a multi component mat which is generally designated by reference numeral 10 and an upper tray thereon, the tray being generally designated by reference numeral 12.

As may be best seen in FIG. 2, mat 10 is formed to have an upper fabric layer 14. Upper fabric layer 14 is preferably formed of a polyester material so as to be permeable to liquids. The upper fabric layer 14 may be fabricated with different textures and colors to match/contrast with the seat upholstering and/or floor carpeting.

Underneath upper fabric layer 14, there is provided absorbent layer 16 which is designed to absorb liquid passing through upper fabric layer 14. Preferably, absorbent layer 16 has a thickness of between 5 and 20 mm and more preferably, between 7 and 12 mm. It preferably can absorb at least 6 times its weight in water and may be formed of many different suitable synthetic materials.

Underlying absorbent layer 16 is an impermeable layer 18 which would typically have a thickness of between 1 and 3 mm and preferably is formed of a polyurethane. It is secured to absorbent layer 16 by any suitable means such as by an adhesive. There is also provided a lower fabric layer 20 which may be similar to upper fabric layer 14. It also can be formed of a suitable material such as polyester. It can be formed of a different color or texture than upper fabric layer 14. The primary function of lower fabric layer 20 is to provide a protective coating for impermeable layer 18.

In one embodiment of the present invention, the carpet protection system utilizes tray 12 which may be formed of a conventional rubber or plastic material used for such trays. Tray 12 will have a bottom 24 with upstanding ribs 26 therebetween. Tray 12 has a plurality of drainage apertures 28 formed therein to permit drainage of liquid to mat 10.

In the embodiment shown in FIG. 1, which would typically be used in a vehicle having bucket seats, there is provided a central mat portion 32 along with a front mat portion 34. A right hand side mat portion 36 and a left hand side mat portion 38 complete the protective portions. It will be noted that between left hand side portion 38 and central portion 32, there is a space 40 for typical levers such as used to release the trunk and/or gas cap cover.

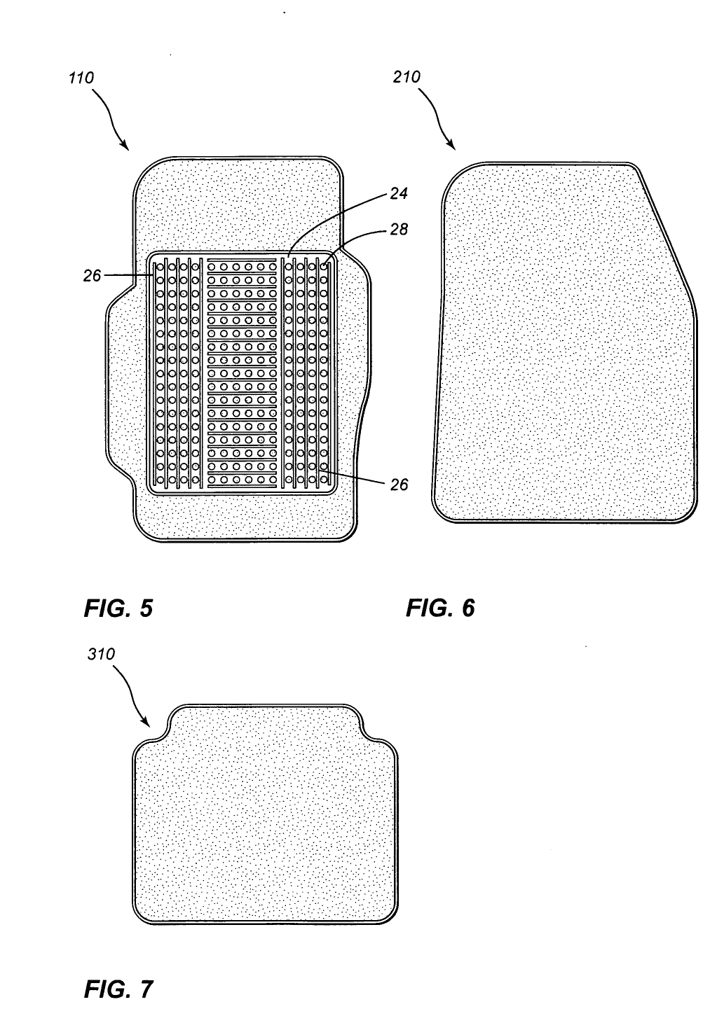

Naturally, many different configurations may be utilized depending on the particular vehicle and the amount of protection desired. Thus, referring to FIG. 5, there is illustrated a mat 110 which is operative to protect the central floor portion in a conventional manner.

In FIG. 6, there is illustrated a floor mat 210 which may be utilized by itself on the floor or in conjunction with a tray. A still further configuration of a mat 310 is shown in FIG. 7.

It will be understood that the above described embodiments are for purposes of illustration only and that changes and modifications may be made thereto without departing from spirit and scope of the invention.

I claim:

1. A mat suitable for protecting the floor of a vehicle, the mat comprising:
an upper fabric layer permeable to a liquid;
a central absorbent layer underlying said fabric layer; and
an impermeable layer underlying said absorbent layer.

2. The mat of claim 1 further including a lower fabric layer underlying said impermeable layer.

3. The mat of claim 1 wherein said absorbent layer is comprised of a synthetic material, said absorbent layer being capable of absorbing at least 6 times its own weight of liquid.

4. The mat of claim 2 wherein said impermeable layer is formed of a polyurethane material adhesively secured to said impermeable layer.

5. The mat of claim 2 wherein said upper fabric layer is formed of a polyester material.

6. The mat of claim 5 wherein said lower fabric layer is formed of a polyester material.

7. The mat of claim 3 wherein said absorbent layer has a thickness of between 5 mm and 20 mm.

8. The mat of claim 7 wherein said absorbent layer has a thickness of between 7 mm and 12 mm.

9. A carpet protection system comprising a mat and a tray, the mat comprising:
an upper fabric layer permeable to a liquid;
a central absorbent layer underlying said fabric layer;
an impermeable layer underlying said absorbent layer; and
said tray having a bottom, with a plurality of ribs extending outwardly from said bottom, and a plurality of apertures formed in said bottom such that liquid on said tray will drain to said mat.

10. The carpet protection system of claim 1 further including a lower fabric layer underlying said impermeable layer on said mat.

11. The mat of claim 10 wherein said absorbent layers are comprised of a synthetic material, said absorbent material being capable of absorbing at least six times its own weight of liquid.
